(19) United States
(12) Patent Application Publication
(10) Pub. No.: US 2005/0236004 A1
(43) Pub. Date: Oct. 27, 2005

(54) Healthcare model of wellness

(76) Inventors: Timothy J. Magnuson, Austin, TX (US); Edward E. DcRouin, Altamonte Springs, FL (US); Richard F. Long, Oviedo, FL (US)

Correspondence Address: HOWISON & ARNOTT, L.L.P, P.O. BOX 741715, DALLAS, TX, 75374-1715, US

(21) Appl. No.: 10/808,644

(22) Filed: Mar. 25, 2004

(51) Int. Cl. G06F 17/00

(52) U.S. Cl. 128/898; 705/3

(57) ABSTRACT

Healthcare model of wellness. A method is disclosed for monitoring the wellness state of a given human body. Measurable parameters of the physiologic metabolism of the the given human body are first sensed and then an interpretation is made of interpreted parameters of the physiologic metabolism of the given human body. This interpretation is made through the interpretation of the human brain associated with the give human body. The sensed measured parameters and the determined interpreted parameters comprise an input vector. This input vector is processed through a model of the given human body that is trained on a training data set comprised of historical measured parameters of the physiologic metabolism of the given human body that are sensed over time in conjunction with historical interpreted parameters of the physiologic metabolism of the given human body. The input vector comprises less than the set of historical measured parameters and the set of historical interpreted parameters, the output of the model providing a prediction of wellness of the given human body.

### TECHNICAL FIELD OF THE INVENTION

The present invention pertains in general to systems that model the physiological activities of the human body and, more particularly, to a system that models wellness for an individual.

### BACKGROUND OF THE INVENTION

The human body is a very complex physiological system that includes a plurality of interacting sub-systems, such as the hepatic system, the cardiovascular system, the digestive system, etc. Each of the systems is a pseudo stand alone system that is operable to perform a substantially dedicated function, but which function is weakly or strongly coupled with the operation of other systems in the body. Each system receives some type of stimulus, either from other systems in the body or from external sources, for the purpose of performing its function.

When the body is in a healthy state and all systems are in “balance” an individual will have a certain sense of “wellness.” When an imbalance occurs in the systems, then an individual will experience some type of discomfort or sense of ill feeling. For most ailments and maladies, the physiological systems of the human body will correct for these maladies and bring the body back into a stable condition. However, modern medicine often can speed up this process and, in some cases where the body is not able to stabilize itself, assist in reaching a stable condition. This is facilitated through a number of steps. The first step is diagnosis. A physician will utilize numerous techniques to determine what is the cause of the malady. The first is to question a patient as to what they perceive as the problem, i.e., what hurts. However, this portion of the diagnostic procedure can be misleading to a physician due to the fact that some patients perceive pain where there is no pain and symptoms that don't exist, which is sometimes referred to as being psychosomatic. The physician records this information and then proceeds to the next step of diagnosis, that being the use of external diagnostic procedures. The most common of these is general observation of the physiologic system through the use of blood pressure measurements, EKGs, the use of the stethoscope, etc. Additionally, various chemical analytic techniques can be performed relating to such things as blood chemistry, urine chemistry, etc. This typical step is substantially noninvasive. The physician will then correlate all of this information and determine if even further diagnostic procedures must be utilized. Sometimes, physicians must resort to invasive operations to further define the cause of the patient's discomfort, such as exploratory surgery, biopsies, etc. When all of these diagnostic procedures are complete, the physician can then determine a course of treatment. This course of treatment may be nothing more than to recommend a change in lifestyle, or just to observe further. It may result in prescription of certain medications followed by observation or even surgical procedures and the such. The whole purpose of all of these procedures is to bring the patient back to a level of stability in their physiological system.

In order to assist a physician in the diagnostic procedure, modeling systems have been developed that model certain aspects of various individual physiological systems or the entire body. These models have been facilitated using Artificial Neural Networks (ANN) that accept various inputs and then provide an output that is the result of processing the input information through a stored representation of a physiological process. These ANNs have been utilized in the diagnostic procedure for the purpose of detecting such things as cancer and heart problems. In addition to ANNs, various linear models can also be utilized to model various aspects of the physiological system. These models are then used to predict a condition based upon the various inputs. For example, a model can be generated for the cardiovascular system. By providing inputs to the system such as blood pressure information, EKGs, etc., an algorithmic result can provide an indication of the state of that particular physiological system. Further, utilizing a non-linear system such as a neural network, a prediction of a future aspect of the physiological system can be provided.

### SUMMARY OF THE INVENTION

The present invention disclosed and claimed herein, in one aspect thereof, comprisesmethod for monitoring the wellness state of a given human body. Measurable parameters of the physiologic metabolism of the given human body are first sensed and then an interpretation is made of interpreted parameters of the physiologic metabolism of the given human body. This interpretation is made through the interpretation of the human brain associated with the given human body. The sensed measured parameters and the determined interpreted parameters comprise an input vector. This input vector is processed through a model of the given human body that is trained on a training data set comprised of historical measured parameters of the physiologic metabolism of the given human body that are sensed over time in conjunction with historical interpreted parameters of the physiologic metabolism of the given human body. The input vector comprises less than the set of historical measured parameters and the set of historical interpreted parameters, the output of the model providing a prediction of wellness of the given human body.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an overall diagram of the physiological systems of the human body;

FIG. 2 illustrates a detail of the various physiological systems and the modeling thereof;

FIG. 3 illustrates a diagrammatic view of the training for the model;

FIG. 4 illustrates a diagrammatic view of a control loop wherein the model is operable to generate external controls;

FIG. 5 illustrates a diagrammatic view of information provided to the model during the operation thereof including the wellness output;

FIG. 6 illustrates a flow chart for training of the model;

FIG. 7 illustrates a different diagrammatic view of the model of the interaction between the created model and a physiological system;

FIG. 8 illustrates a more detailed diagrammatic view of the physiological model;

FIG. 9 illustrates a diagrammatic view of the first principles engine;

FIG. 10 illustrates a diagrammatic view of a model during training;

FIG. 11 illustrates a flow chart for the data input that is utilized between operations;

FIG. 12 illustrates a flow chart for the training operation;

FIG. 13 illustrates a plot of exemplary data that is collected during the data collection operation on the sheet illustrated in FIG. 11;

FIG. 14 illustrates a diagrammatic view of a model during sensitivity analysis;

FIG. 15 illustrates a flow chart for the sensitivity analysis operation;

FIGS. 16 and 17 illustrate plots resulting from the sensitivity analysis determination;

FIG. 18 illustrates one of the first principles models; and

FIG. 19 illustrates the output of the model of FIG. 18 utilized to calculate the blood serum level model of a drug over time.

### DETAILED DESCRIPTION OF THE INVENTION

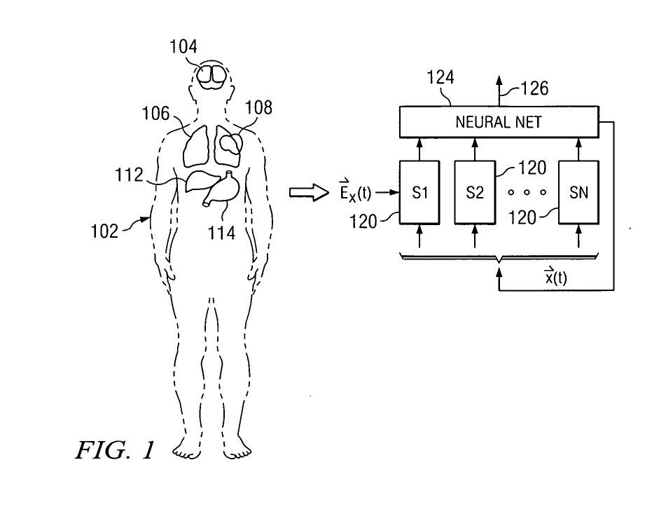

Referring now to FIG. 1, there is illustrated a diagrammatic view of the human body and the various physiological systems illustrated therein. The human body, represented by reference numeral 102, is comprised of a plurality of physiological systems, such as the neural system having a brain 104 at the center thereof, the pulmonary system having lungs 106 associated therewith, a cardiovascular system having a heart 108 at the center thereof, a hepatic system having a liver 112 at the center thereof and a digestive system having a stomach 114 at the center thereof. Of course, there are many more physiological systems that play major or minor roles in the functioning of the human body, which physiological systems are typically loosely or strongly coupled to each other. Each of these systems is represented as a physiological system 120 labeled S1, S2, . . . , SN. Each has the ability to receive inputs, process those inputs and provide an output. For example, the cardiovascular system could receive as an input an increase in adrenalin and provide as an output increased blood flow.

The physiological systems 120 are subject to internal variations that can be the result of interactions with the other physiological systems, and can also be influenced by various external inputs represented by a Eₓ(t). The outputs of each of the physiological systems are utilized by the body for various operations. They may directly affect another system, such as the pancreas generating insulin to control sugar levels that can directly or indirectly affect other systems. All of these physiological systems can have some measurable aspect thereof forwarded to the brain, which is represented by a physiological neural network 124. The physiological neural network 124, this being the brain 104, can provide various control signals back to the inputs of the physiological systems 120 to provide for the control thereof or it can provide a general cognitive output 126. This cognitive output can be an outward expression of pain, discomfort, or an indication of the general state of well being of the individual. The difference between the neural network 124 and all of the other physiological systems is that neural network 124 can provide a cognitive impression of the overall physiological state of that individual. This neural network 124 is an adaptive neural network in that it contains a learned representation which affects the type of control feedback able to be provided to the other physiological systems based upon certain perceived inputs. Additionally, the neural network 124 can actually provide deleterious feedback inputs to the various systems 120.

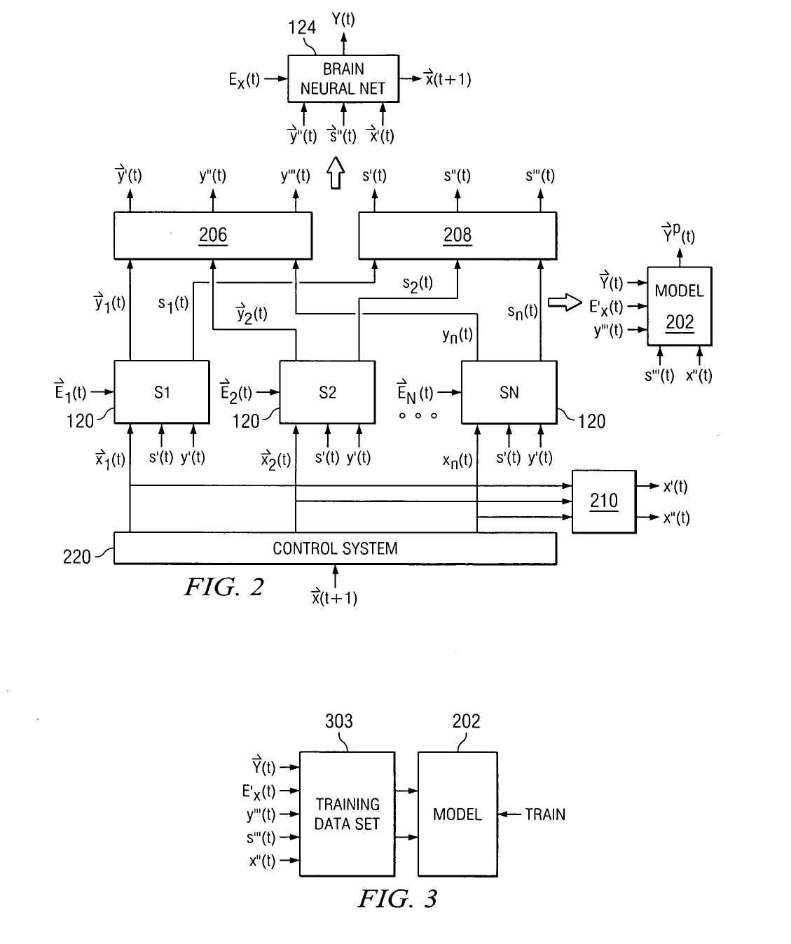

Referring now to FIG. 2, there is illustrated a more detailed diagrammatic view of the physiological system and the interaction thereof with a model 202. Each of the physiological systems 120 is operable to be provided with input vectors x₁(t), x₂(t), . . . , xₙ(t), respectively. Each of these vectors comprise a plurality of separate inputs that are received by the system, which inputs are basically controllable. For example, in the digestive system, the brain 124 can provide a stimulation of the vegas nerve to control the generation of stomach acid. Additionally, the other inputs to the digestive system could be food and the general intake thereto. There will also be provided external inputs to the stomach, for example, which are provided by a vector E₁(t). Each of the systems 120 has an associated external input vector. This, for the stomach, comprises any of a plurality of inputs. For example, one external input could be the presence of pressure on the abdomen. In the late nineteenth century, corsets were very popular among women to maintain their figure. However, this exerted an excessive pressure on the abdomen and caused numerous digestive system problems. Also, this exertion of pressure at a first time may cause digestive problems at a later time, such that an immediate relationship between cause and effect may not be obvious.

Each of the systems 120 provides as an output a resultant vector y₁(t), y₂(t), . . . , yₙ(t), this being the basic result of the overall operation of the system. In the digestive system, for example, this would be the effective removal of nutrients from the food and the elimination of waste from the body. In the cardiovascular system, this would be the maintenance of blood flow under all conditions to adequately oxygenate the various tissues. In addition to the resultant vector, there will also be measurable outputs which are represented by a vector s(t) for each system, yielding vectors s₁(t), s₂(t), . . . , sₙ(t). These are internally measurable aspects of the system, of which one or more of the values making up the vectors actually may not be measurable external to the body and can thus only be utilized internal to the body. For example, the temperature of one system may be sensed, which temperature is utilized by another system for the purpose of that system creating a result that will affect another system. There might be a situation where the adrenal gland is stimulated to release adrenalin which will then cause restriction around certain blood vessels to redirect flow to certain systems or, alternatively, relax certain blood vessels to increase flow to the systems.

Each of the systems is illustrated as having an output vector(t) as y₁(t), y₂(t), . . . , yₙ(t). These are the actual result or output of a particular system. Each of these outputs is filtered in a filter 206 to provide various outputs, for discussion purposes, that can be routed to different areas. There are illustrated three different output vectors, y′(t), y″(t) and y′″(t). The vector y′(t) is a vector that yields a result that is provided as an input to another system, this being one or more of the output values of one or more of the systems 120. The output vector y″(t) is an output that is provided as an input to the brain 124 and the output vector y′″(t) is an output that can be measured. With respect to the vector y′″(t), this could be the blood pressure associated with the cardiovascular system operation. This is an output that typically would not necessarily be utilized internally, but it would be utilized externally and, as such, this is an output that can be measured externally, whereas oxygen transfer to various tissues is something that is difficult to measure externally, but which is an output that can be internally perceived by various systems, this being one of the values in the output vector y′(t). It is noted that there are many outputs that cannot be measured externally without great difficulty, if at all.

With respect to the measurable outputs from each of the systems 120, the vector s(t) from each of the models 120 is input to a filter 208 to basically, for illustrative purposes, provide three sets of output vectors, s′(t), s″(t) and s′″(t). Again, the measurable output s′(t) is an output that can be routed back to the two other systems as an input, the vector s″(t) is a measurable output that is provided to the brain 124 and the output s′″(t) is a measurable output that can actually be measured external to the body. A third filter 210 is provided for writing subsets of the vector x(t) as x′(t) and x″(t), x′(t) providing a measure of the input control values that can be provided to the brain 124, the value x″(t) providing a measure of the control inputs to the systems 120 that can be output to model 202. It should be noted that all of the outputs from either of the filters 206, 208 or 210 are not mutually exclusive, i.e., it could be that there are measurable outputs that can be measured external to the body and also can be directly measured by the brain or directly input to another one of the systems, i.e., these are strongly correlated or coupled values.

Each of the systems 120 is operable to receive the control input x(t), one or more of the values associated with the vector s(t) and one or more of the values associated with the vector y′(t). With these inputs, and the external input, the system will generate the result.

As an example, consider a runner. The runner will perceive an external input of a hill or an increase in resistance which will result in an external input requiring the system to exert more effort, from the brain for example. The cardiovascular system will provide as part of the vector y(t) associated therewith additional blood flow for the muscles of the legs and there can be provided as a measurable output, pain. Additionally, if there is an over exertion, a build up of lactic acid can be provided as an input which will affect the operation of the overall system.

The brain 124 is operable to receive various outputs of the operation of the systems 120 indicating the results, i.e., the perception of running and the perception of increase in resistance, it can receive measurable inputs from the various systems, i.e., pain from the legs during running and it can also receive indications of inputs from other systems to specific systems, the vector X′(t).

The brain 124 is operable to provide a cognitive output Y(t) that allows an individual to perceive aspects of its environment and its state of wellness that can be communicated to another, or utilized for another purpose. The brain 124 also can provide a control output x(t+1) that is a control output that is input to a control system 220, control system 220 being a physiological control system. Since the brain 124 contains a learned representation of the overall physiological system of the human body, it can perceive all of the inputs thereto, including any external inputs applied to the various systems, and predict an action. This, as described herein above, is to perceive an increase in resistance during running and to exert more energy. This is a predictive operation.

The model 202 is also a predictive model, which is either a linear model or a non-linear model, which in both cases provides a stored representation of certain aspects of the physiological system. This is either a first principles model, which is based upon algorithms or it can be a linear system, or a non-linear system such as a neural network that is trained on a training data set. In either case, the model 202 contains a learned representation of a physiological system. These are conventional models.

The model 202 is operable to receive various inputs. It is operable to perceive the externally measurable results of one or more of the systems as the vector y′″(t), the measurable variables s′″(t) and the measurable control inputs x″(t). Additionally, the cognitive output Y(t) is also input to the model 202. This will yield a predictive result Y^{(p)}(t) that is a prediction of the state of wellness of the body. As will be described herein below, what is input to the model from the brain are indications of pain, discomfort and general aspect of the wellness condition as perceived by the brain 124. Therefore, this model 202 is not a general model of a physiological system but, rather, it is a model of that individual's physiological system parameterized by the interpretation provided by the associated human brain. It may be that the brain 124 has been conditioned, for whatever reason, to over-exaggerate a certain condition, perceive pain where pain does not exist, etc. As such, the physiological system for one person may not result in any perception of lack of well being for the same condition as that of another individual who experiences a great deal of lack of well being. As such, the prediction provided by the model for one individual may not give the same prediction for another individual, i.e., this model is specifically tailored to a particular individual, which can be important in assessing the treatment of an individual.

Referring now to FIG. 3, there is illustrated a diagrammatic view of the training operation for the model 202. The model 202 must be trained or parameterized, depending upon the type of model utilized. Typically, this training and parameterizing is derived through the use of a training data set 303. The training data set 303 is a collection of all of the measurable parameters, being the values y′″(t), s′″(t), x″(t), external values E_{x′}(t) and Y(t) measured over time. This data is collected over time and can actually have a time delay value associated therewith. The model 202 is trained utilizing this information in conventional manners. For example, with a neural network, a non-linear model, the typical training method is to utilize a back propagation technique wherein the hidden layer for the neural network is trained based upon the outputs and inputs thereto. This is a conventional operation. Once a model is trained, then it can be utilized to provide a predictive output.

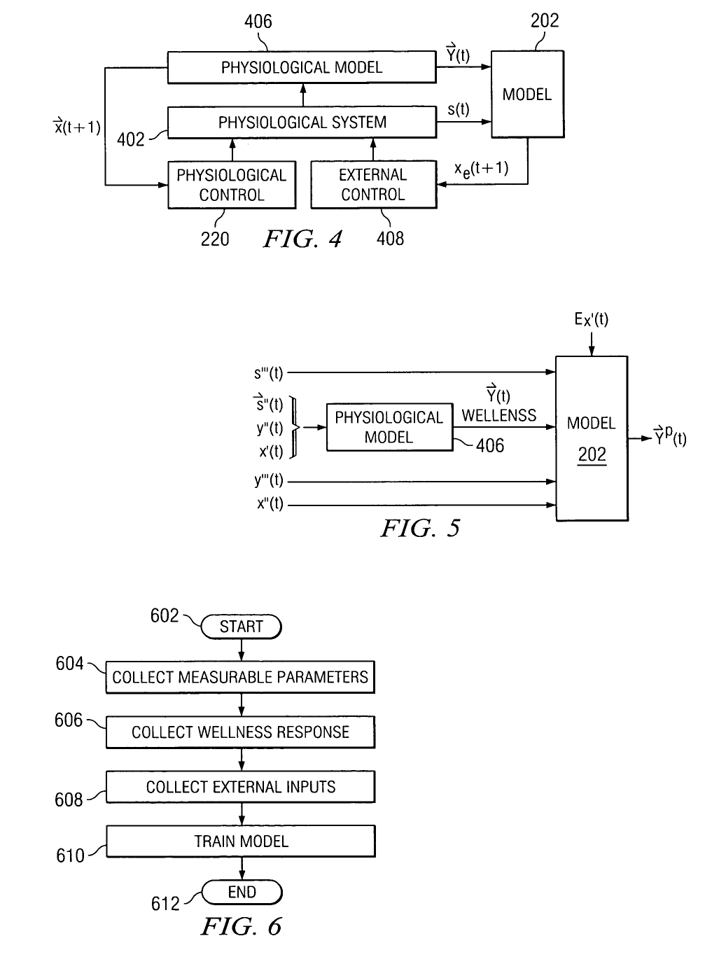

Referring now to FIG. 4, there is illustrated a diagrammatic view of the overall physiological system utilized in a control operation. In this operation, a physiological system is represented by a general block 402 which is associated therewith the physiological control system 220. The brain 124 is represented by a physiological model 406 that is operable to generate control values x(t+1) for input to the physiological control system 220. In addition, there is provided an external control system 408 which receives an output from the model 202. The model 202 is, in this embodiment, designed to predict a treatment or a control. This could be as simple as medication. This provides an additional input x(t) to the physiological system 402. This input will be a value x_{c}(t+1) generated by the model 202.

Referring now to FIG. 5, there is illustrated a more simplified diagrammatic view of how the model is utilized, both for training and for prediction. In this system, it can be seen that the various measurable outputs s′″(t), y′″(t) and x″(t) can all be input to the model 202 in addition to the wellness aspect from the physiological model 406. This, in addition to external inputs E′ₓ(t) is used by the model 202 to provide a predictive value Y^{P}(t).

Referring now to FIG. 6, there is illustrated a flow chart depicting the operation of training the model. This is initiated at block 602 and then proceeds to a block 604 to collect measurable parameters from the physiological system, i.e., the human body. These parameters can be all inclusive or they can just be spotty measurements. The program then flows to a function block 606 to collect wellness responses from the individual, these typically correlated in time with the measurable parameters. The program then flows to a function block 608 to collect external inputs, i.e., temperature, humidity, lighting, and other environmental factors such pollen levels, air quality, barometric pressure, mold count, etc. The program then flows to a function block 610 to utilize all of the collected data and train the model and then to a function block 612 to end the operation—this is when a model is trained. It should be noted, however, that the model can continually be trained with updated data to more fully refine the model and more fully define the stored representation, which stored representation is utilized to map the inputs to the predicted output.

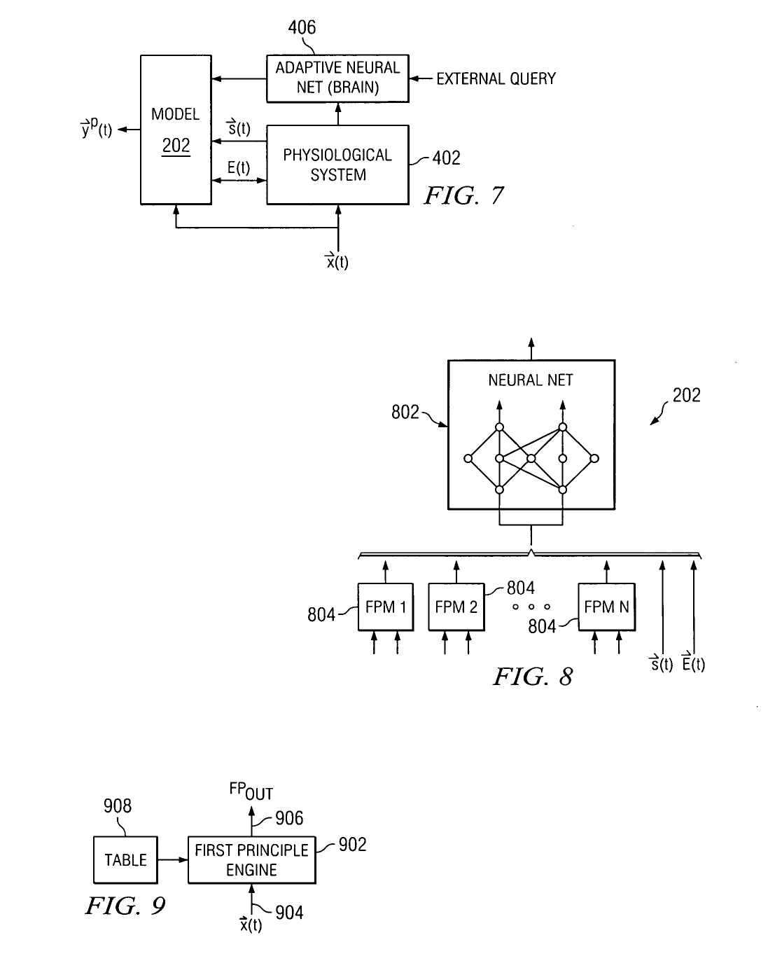

Referring now to FIG. 7, there is illustrated a more simplified model of that illustrated in FIG. 4. In the embodiment of FIG. 7, there is illustrated a set of control inputs x(t) that comprises a vector of inputs. These inputs are provided as inputs to both the physiological system 402 and the model 202. The model 202 also receives inputs from the brain, the physiological model 406, which provides outputs in response to external queries. These queries allow the model 406 to determine certain aspects of the physiological system 402 as interpreted by the brain, i.e., such as pain, discomfort, etc. External inputs such as humidity, ambient temperature, pollen levels, mold count, etc. are also input to both the physiological system 402 and to the model 202. The model 202 is then operable to, after being trained, make a prediction over time. Since the model 202 is trained on a time series of data, the prediction provided thereby can predict a future physiological response to certain inputs. This will be described in more detail herein below.

Referring now to FIG. 8, there is illustrated a more detailed diagrammatic view of the model 202. The model 202 is comprised of a non-linear neural network 802, which neural network 802 is operable to store a representation of the physiological system 402 which is comprised of a mapping or hidden layer containing a stored representation of the system, an input layer and an output layer. The mapping or hidden layer maps the inputs to the outputs through this stored representation such that when an input is provided thereto, a prediction will be provided on the output thereof. These neural networks are trained, as noted herein above, by such techniques as Back Propagation wherein the training set of data comprised of known inputs and known outputs are provided to the model and the “weights” of the model are determined. If enough historical data about the physiological system could be obtained, this model could be entirely mapped through the stored representation. However, there are a number of physiological systems in the human body that are difficult to measure. For example, it would be very easy to determine the type of food an individual consumes, the type of medications taken by the individual , but it is difficult, for example, to determine blood serum levels of a drug at any one point in time and over a time period. An individual's wellness or condition can largely be a function of how well a drug is delivered and how well they tolerate that drug, in addition to the type of food they consume and how well the food is digested, etc. For example, an individual may take a blood pressure medicine in the morning and that blood pressure medicine in the form of a time release drug that is operable to distribute the medication to the system over a longer period of time. Alternatively, some drugs are operable to be metabolized very quickly, such as aspirin, which requires the drug to be taken multiple times during the day. In any event, the incident of taking the drug and the time at which the drug actually provides any therapeutic effect is typically not the same, i.e., the result is not instantaneous. Thus, there is a delay that should be accounted for in the model. Of course, an individual could have their blood serum level monitored for various medications over a specified period of time, as well as the physiological reaction to different foods, etc. However, this is not practical in most situations.

In the present disclosed system, there are provided a plurality of first principles models 804 that are operable to receive various inputs and then model these inputs to provide a time response for these inputs as applicable to the physiological system. For example, if a medication is taken, the blood serum level of this medication is what is important and, thus, over time, the serum level will be output by the appropriate first principles model 804 and provided as input to the neural network 802, i.e., this first principles model 804 associated with that drug is used to “populate” the input time series to the neural network 802. Other examples include carbohydrate models. Although food is ingested at a certain time, the question is how the food is ingested and taken up by the physiological system. Since food is comprised of a number of constituents, such as carbohydrates, proteins, vitamins, minerals, fats, etc., it is necessary to break the constituents down to the various elements thereof and make a determination as to the actual distribution thereof to the physiological system over time and the intake thereof. For example, it may be that a very simple sugar is ingested which will cause a slight level of euphoria to an individual on a relatively instantaneous basis. However, more complex sugars require more time to be broken down and metabolized by a physiological system. As such, an individual may have a feeling of a high level of energy hours after ingesting certain food products. Another example is caffeine, which provides a stimulating effect almost immediately after ingestion thereof. However, caffeine may reside in the blood for ten or fifteen hours, such that the individual will be unable to sleep five to ten hours after ingestion of the caffeine. Thus, by taking the single instance of the ingestion of the caffeine laced product such as coffee or tea, for example, the first principles model 804 associated therewith can model the distribution and metabolism of the caffeine over time such that a relationship between a feeling of wellness or lack thereof and the ingested product such as caffeine can be determined. There are some inputs to the model that can be utilized by the neural network 802 which do not need to be processed by a model, as they do represent the state of the physiological system at that point in time, i.e., these measurements have a temporal aspect thereto that does not have to be modeled. These are such things as blood pressure measurements, body temperature, ambient temperature, etc. For example, if an individual is having headaches at a certain time of the day, there will be a strong relationship proximate in time thereto with respect to a high systolic/diastolic pressure, which does not need to be processed through a first principles model.

The predicted output of a model 802 can be any output upon which it was trained. For example, the model may be trained on pain or such things as migraine headaches. If a prediction is made on a migraine headache, for example, the ingestion of a food product that is heavily laced with Monosodium Glutenate (MSG) at the meal could result in the prediction that a migraine headache will result four hours later. Intestinal discomfort could be another output upon which the model would be trained, such that ingestion of certain foodstuff or medications at one point in time could allow for prediction of intestinal discomfort at a much later time. Other similar maladies could be gastric acid reflux disease (GARD) which is also something that may occur much later in time as a result of ingestion of certain products. Thus, the first principles models recognize that the instance of ingestion of a medication or a food product is metabolized over time. It is also recognized that a general first principles model can be represented with an algorithm that is parameterized by certain constants and the such that provide for a “general” model of that metabolic process that is applicable to most physiological systems and not necessarily to that individual. However, any of the first principles models 804 could be replaced by either a first principles model that is specific to that individual, an algorithm is designed for that individual specifically, or by a neural network that is a non-linear network trained on that individual's historical data. For example, if it were possible to run a glucose tolerance test on an individual, a table for that individual's response to ingestion of simple and complex sugars could be stored in a table and provided as a time series to the neural network 802 during training and during actual operation. Further, a non-linear network could utilize and train on that data set. However, as will be described herein below, even though first principles modes for generalized metabolic functions are utilized as inputs, the primary model is parameterized during training by the individual's feeling of wellness.

Referring now to FIG. 9, there is illustrated a simplified diagram of a general first principles model 902. The first principles model 902 is operable to receive inputs on an input 904 and provide outputs on an output 906. The first principles engine that is a part of the model is an algorithm. This algorithm is typically parameterized for its particular function by parameters and data stored in a table 908. For example, the same model could be utilized for any drug. However, the intake and metabolism a particular drug is a function of its intake, its uptake and excretion, all of which are fairly well known aspects of the drug. The table 908 would therefore parameterize the model for a particular drug. Additionally, a more complex aspect thereof is the interaction of multiple drugs. In any event, the table 908 is utilized by the first principles's engine to provide an overall model of the metabolism of certain drugs, fats, carbohydrates, etc. over time from a point in time that such drugs, fats, carbohydrates, etc., were ingested. This single instance of ingestion will be extrapolated to a time series of data inputs for input to the neural network for either training or operation in the form of prediction thereof.

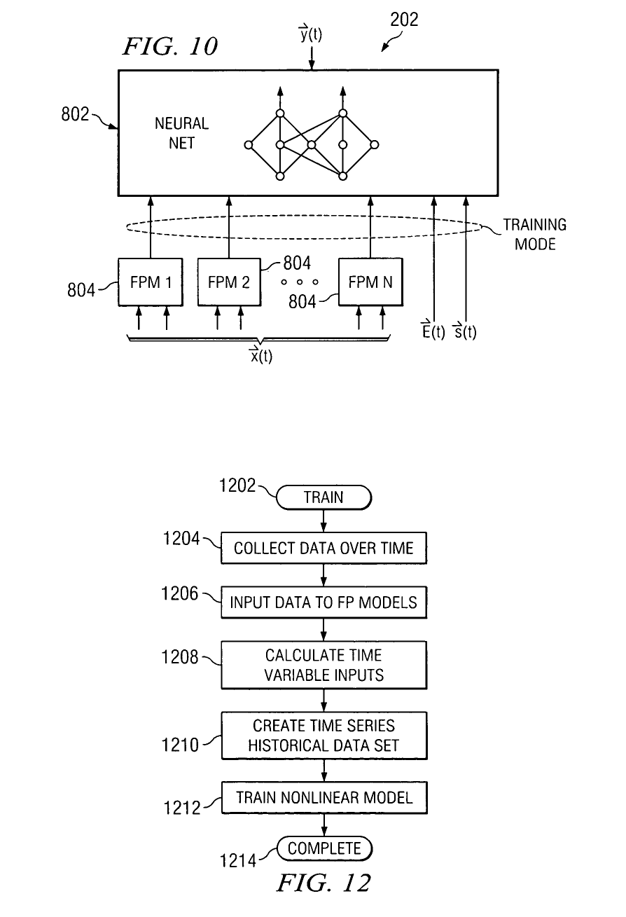

Referring now to FIG. 10, there is illustrated a detail of the model 202 during training. This model 202, as noted herein above, is comprised of the neural network 802 and the first principles models 804. The first principles models 804 each receive one or more of the input vectors x(t), the input vector comprised of inputs x₀(t), x₁(t) . . . , xₙ(t), some of the first principles models 804 receiving discrete and separate ones of these inputs and some receiving common ones of these inputs. The other inputs are comprised of the external disturbances E(t) and the measurable variables s(t), these being such things as blood pressure, urinalysis results, body temperature, etc. Additionally, there will be a plurality of determined outputs that are part of the data set that were utilized to create the input data x(t), the external disturbance data, E(t) and the measurable variables s(t). This will be a time series of data that a patient will provide in response to queries. As will be described herein below, a patient will track all of this information over a period of time and provide this information as inputs to the network. The first principles models, as described herein above, are operable to take certain data that does not lend itself, in and of itself, to a time series, but is subject to be metabolized in such a manner that the distribution to the physiological system, i.e., the body, is in actuality a time series of data inputs. Thus, the neural network 802 is trained on this time series of data inputs output by each of the first principles models 804 and also the time series associated with the measurable variables and the external inputs. The output results relating thereto would be such things as pain, for example, intestinal discomfort, fatigue, etc. These are variables or values that are provided by a patient that are individual to that patient. It is how the patient perceives their “wellness” as indicated by responses to various queries. As noted herein above, individuals with high pain thresholds would provide different responses for similar inputs than a person with a low pain threshold. Further, there may be some malady heretofore undiscovered with an individual that will result in different responses to the queries for the same identical inputs. Thus, the following relationship will be modeled in the neural network:
y(t)=f(FP1(x(t),P,t),FP2(x(t),P,t), . . . FPN(x(t),P,t),E(t),s(t))
Thus, the training of a neural network is a function of the time series output of each of the first principles models, the external inputs and measurable variables.

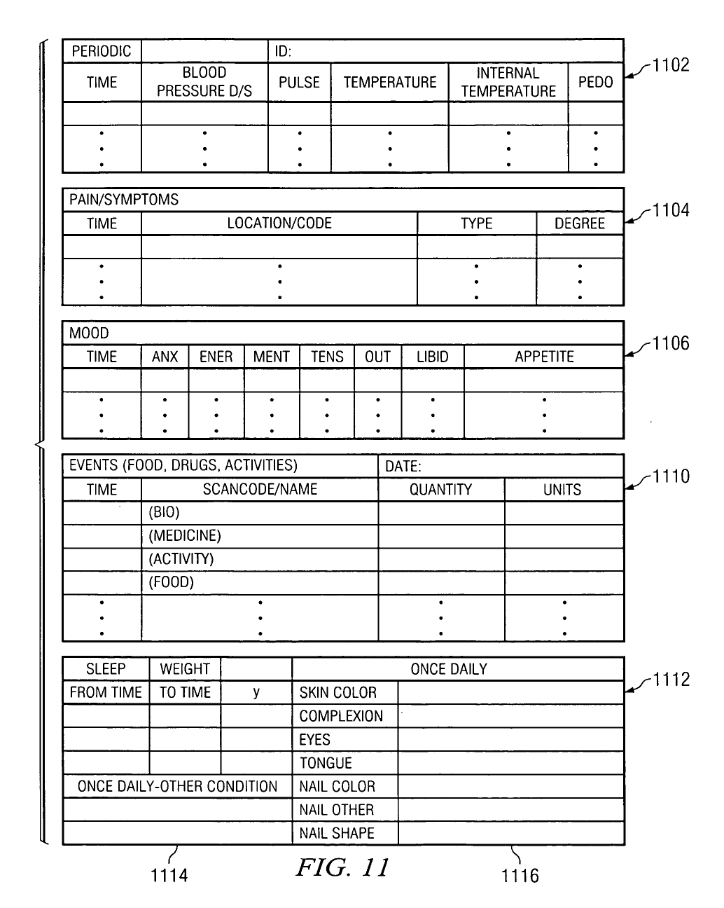

Referring now to FIG. 11, there is illustrated a data sheet to allow the individual to input various information into the system. This is provided to the patient for filling out over a predetermined amount of time. Multiple sheets are typically utilized over an extended time period, such as ten consecutive days. The object is to provide as much information as possible for the training operation. In the example of FIG. 11, it should be understood that many data types or data fields could be provided. These are by way of example only. In the embodiment of FIG. 11, there is illustrated a particular table section 1102 which is associated with the cardiovascular system. This is evidenced by measurements such as the blood pressure, pulse, body temperature, a pedometer output, etc. These measurements are all correlated with time. A second section 1104 is provided for pain and symptoms. Again, this is parameterized on time and provides location of the pain which can be input as a code which could be provided to the patient. The type of pain can be classified as to the degree, i.e., mild to severe. This could be a rating system on a scale of “0” through “10.” A third section 1106 is provided that allows an individual to give an indication of their mood. Again, this is parameterized on time. There is provided in this example a column for anxiety, a column for energy level, a column for mental state, a column for attention, a column for libido, and a column for appetite. There, of course, could be many other indicators. These indicators are how the individual perceives their wellness. This is something that is an unmeasurable parameter. It is only a perception that is a function of the way the brain works for that individual. Further, this will vary dramatically among individuals for the same values of measurable variables in section 1102.

There is also provided an input section 1110. This is a section that is associated with events that occur, associated with food, drugs and activities. These are events that typically occur once and are input as a single unit. As noted herein above, these events can be associated with a metabolic time series wherein the single event is actually distributed over time with respect to the manner in which a particular physiological system can metabolize medicines, food and even deal with activities. The columns associated with this section 1110 are parameterized on time as to instance of occurrence and then provide the name of the activity, medicine or food, the quantity associated therewith and the units, if applicable. Another section, section 1112, is provided that is associated with parameters such as sleep and weight, such that there is provided a weight input and a sleep input from one time to another time and when the person was awake or asleep. There is provided a section 1114 for other once daily type inputs, in addition to a section 1116 wherein once daily an individual will determine such things as skin color, complexion, condition of the eyes, the tongue, the nails, etc. These are actually measurable variables that can be provided as an input to the system.

Alternative methods of inputting the data that could be alternatives to the paper data sheet, including a web-based data entry system comprised of a series of electronic forms filled in by the patient or a health-care practitioner acting on behalf of the patient, or alternatively, the use of a handheld device, such as a specialized PDA, to gather the data using a sequence of screens. The handheld device could also incorporate a barcode scanner for scanning barcodes for such things as foods and drugs, among other possible inputs. The patient will collect data using the PDA device and then the doctor would simply plug the device into a cradle to upload it to a server for processing. The doctor would receive a detailed report by email or fax within minutes of uploading the data from the hand-held device.

Referring now to FIG. 12, there is illustrated a flow chart for the training operation. The overall system allows an individual to fill in the query sheet and data sheet in FIG. 11 over time to provide information to the model. When the individual shows up at the physician's office, the physician can submit that historical data set to the system described herein to have a completely untrained model trained on the data set. In this manner, the physician will be provided a model of the physiological system associated with the individual that is parameterized on the individual's interpretation of their “wellness.” As noted herein above, the individual's brain is basically another model of the system that can gain access to multiple inputs not available to an external model. However, this particular model, the brain, is an adaptive model that is adapted over time to many variables, both internal and external and the manner in which that individual's brain interprets the accessible inputs will be different than the interpretation associated with another individual. Thus, once trained, the external model is now able to predict a response at a future time based upon a current incident or a potential incident. The example noted herein above is one where the user could actually input the amount of MSG in a food product that they are about to consume to determine if it will adversely affect them. If they are subject to migraine headaches, for example, the model may indicate that, within two hours, a severe migraine headache will occur.

The flow chart of FIG. 12 is initiated at a block 1202 and then proceeds to a block 1204 to collect data over time, this being the filling in of the sheet of FIG. 11. The program then flows to a function block 1206 to provide input data to the first principles models and then to a flow chart 1208 to calculate the time variable inputs from the first principles models. The program then flows to a function block 1210 to create time series historical data sets from the first principles models and then the program flows to the function block 1212 to train the non-linear model on the historical data set output by the first principles models in addition to the measurable variables and the external disturbances E(t) and S(t). The program then flows to a block 1214 when the training is complete. Again, the training algorithms used for the neural network 802 are conventional, such as Back Propagation.

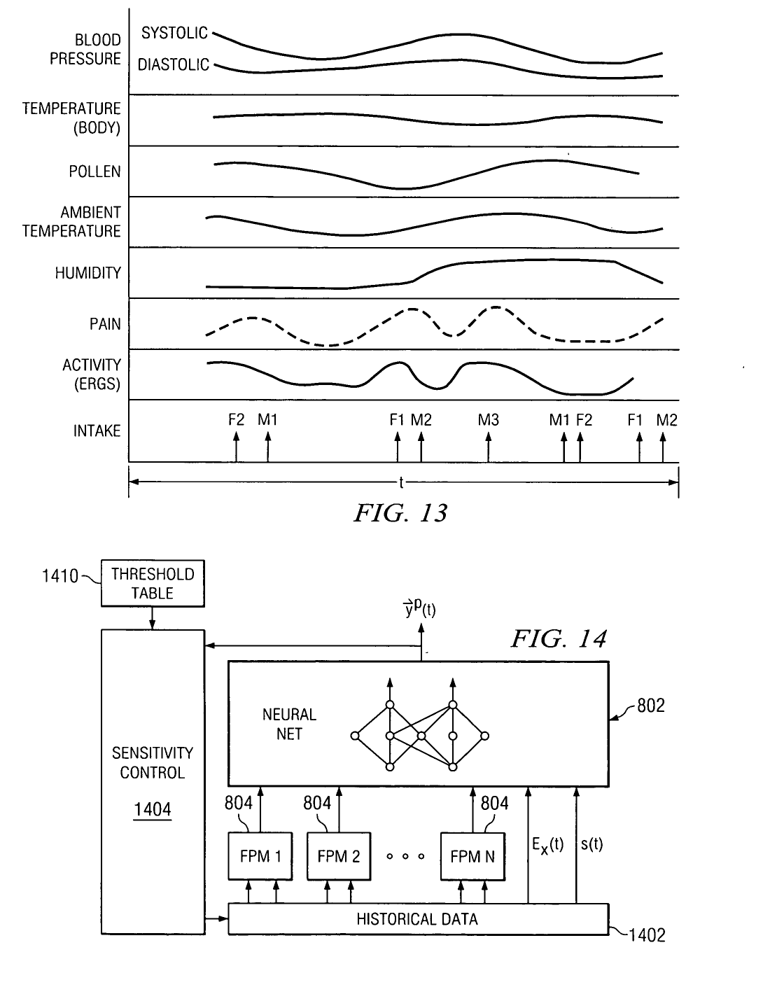

Referring now to FIG. 13, there is illustrated a plot of an example of time events that would be placed onto the sheet of FIG. 11. There is illustrated a blood pressure plot of systolic and diastolic blood pressure levels over time. These could be taken individually by the patient or a 24 hour blood pressure monitor could be attached to the individual to accumulate this data over, for example, 15 minute intervals. These are conventional and allow for the collection of a significant amount of data over a period of time on a patient. The temperature of a body is also provided in one plot over time. These are measurable variables, s(t), wherein additional things such as pollen levels, ambient temperature levels, humidity, mold count, etc. can be measured over time. Note that these data points will be extrapolated over time to provide a synchronized data steam such that all of the data points are on a common time line. These may or may not have a strong effect on the individual or a strong relation to their state of “wellness,” but they do have some relevance. The interpreted aspects of an individual's body, such as pain, mood, etc. are illustrated with one curve for pain. This illustrates the severity of pain, which will be associated with location, etc. on the individual. Also, activity can be provided as an input, as illustrated in FIG. 13. The food intake and medicine intake are provided on a plot which illustrates these as instances. The individual will list the amount of food that is ingested at the time that food is ingested and also the medicines that are ingested and the time that the medicines are ingested or administered. In the illustration of FIG. 13, the time scale is taken over a couple of days. It can be seen that the blood pressure will typically peak in the middle of the day and be at its lowest level in the middle of the night. There is defined at least one major peak and a minor peak showing a span of a couple of days. Illustrated are a number of meals, a morning meal, F1, and an evening meal, F2. Associated with the evening meal are medications M1, and with the morning meal there are associated medications M2. There is provided in between medications M1 and M2 a middle of the day medicine, M3. Again, these are inputs that, in and of themselves, do not directly relate to the way that they are metabolized at the time they are ingested. This is what the first principles models are based on. There could be many of these inputs and, correspondingly, associated first principles models.

Referring now to FIG. 14, there is illustrated a diagrammatic view of the neural network utilized for the purpose of determining the sensitivity of the output on various inputs. This is typically referred to as “sensitivity analysis.” Typically, the prior systems have utilized sensitivity analysis for the purpose of eliminating or reducing the number of inputs to a particular control system. For example, a control system may have over 1,000 inputs. However, some of the inputs have little or no effect on the output. Therefore, what is typically done is to train the network one time on all of the historical data associated with all of the outputs and all of the inputs. Once the network is trained, then all the inputs are set a fixed value, either “0” or an average value for that input. Then a single input is varied between two limits and the output change noted. If the input changes by a factor of 20%, for example, and the output changes by a factor of 10% or more, this may indicate that the output is sensitive to that input. However, some inputs can be varied for a minimum to a maximum with virtually no change in the output. Thus, it is realized that this particular input can be eliminated from the control, such that in a control system situation, it is not necessary to actually measure this input and provide it to the network. Further, it is not necessary to actually train the neural network on this data and this data input can be eliminated during a later training operation. However, there are many relationships between the inputs and the outputs and even between one input to another input that must be accounted for. By setting the values to “0” or a constant average value without more, it may be that this in and of itself affects the accuracy of the sensitivity analysis. Therefore, as will be described herein below, for each input that is varied in the sensitivity analysis, at any point in time, the associated value for the other inputs will be extracted from the historical data sets and provided as an input. For example, in the above example of FIG. 13, it might be that one is looking at the blood serum level for a particular drug over time and the effect that it has on an individual. By varying the blood serum level at a particular point in time, the model will also have the blood pressure associated with that particular point in time from the historical database as an actual input to the network during the sensitivity analysis. This is opposed to just applying an average normal blood pressure value of, for example, 110/70 for all changes in the blood serum level over time. Also, the input of interest is changed as a function of the values of the other inputs at select points in time. For example, at a time t₁, one input will be changed over a test range and all of the historical data for the remaining inputs will be extracted for time t₁and provided to the model. At a later time, t₂, historical data for that time will be extracted from the historical database and the one input again changed over the sensitivity test range for the one input at time t₂, the sensitivity of that input can be determined, and then time incremented.

Referring further to FIG. 14, the neural network 802 is interfaced through the first principles models 804 to a historical data base 1402. The historical data base 1402 contains the historical data vectors, x(t), E(t) and s(t). A sensitivity control block 1404 is operable to evaluate the output and selectively exercise the model over time by selecting one input and varying it over the time period of the data from values that extend from a minimum to a maximum. At each time period that the select data input is being evaluated, the historical data base 1402 provides the time corresponding points of data for the other inputs. The sensitivity control block 1404 interfaces with a threshold table 1410 that provides various thresholds against which the change in the output can be compared. If the change is minimal, then a determination is made that this particular input has a minimal effect on the output. Again, as noted herein above, one example could be that associated with a migraine headache wherein the medications could be varied, the constituents of the food products varied and then a determination made as to which of the various inputs affects the migraine headache. This information then can be provided to a practitioner for the purpose of diagnosing a certain individual's condition.

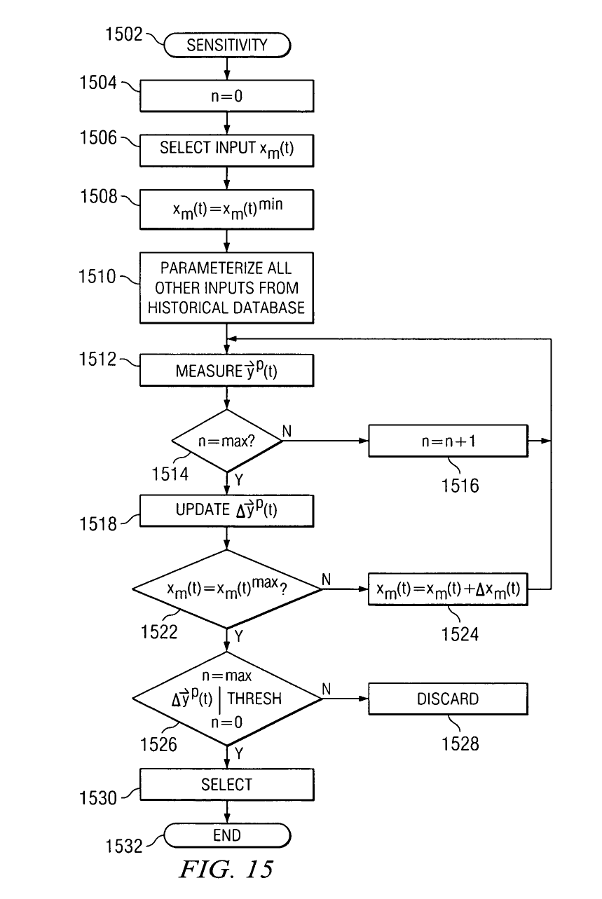

Referring now to FIG. 15, there is illustrated a flow chart for the sensitivity analysis, which is initiated at a block 1502 and then proceeds to a block 1504 where a value of n is set equal to “0.” The program then flows to a function block 1506 wherein one input is selected, and input xₘ(t). The program then flows to a function block 1508 to set the value of xₘ(t) to a minimum value and then to a function block 1510 to parameterize all of the other inputs from the historical data base, i.e., set them to the value that exists for a given time during which the value xₘ(t) is being evaluated. The program then flows to a function block 1512 to measure the value of y^{p}(t), this being the predicted vector of values output by the model. The program then flows to a decision block 1514 to determine if the value of n is the maximum value, the value of n being the time value, tₙ. If this is not the last time increment that is evaluated over the time period of interest, the program will flow along the “N” path to a function block 1516 to increment the time value by incrementing the value of n. The program then flows from function block 1516 to the input of function block 1512. When the value of xₘ(t) is evaluated over the total time period of interest, the program will flow from the decision block 1514 along the “Y” path to a function block 1518 to update the sensitivity response of yₚ(t) in a register. This basically tracks the values of the output over time for the input of interest, xₘ(t). The program then flows to a decision block 1522 in order to determine if the value xₘ(t) is a maximum value for the sensitivity analysis. It should be noted that each input will have a range over which it will be varied. For example, it may be that a certain medication can have the value thereof varied from a minimum to a maximum, such that the first principles model associated therewith will change the blood serum level thereof over time. Of course, there is no need to vary this in small increments, as large increments, i.e., either the dose that the individual will use or no dose can be utilized.

If it is determined that the current value of xₘ(t) is not at maximum, the program will flow along the “N” path to a function block 1524 to increment the input value by a predetermined delta. The program will then flow to the input of function block 1512 to again measure the output of the value over time. This will continue for each incremental value of xₘ(t) until it is maximum. At that time, the program will flow from the decision block 1522 along a “Y” path to a decision block 1526 to determine if the change in the output y^{p}(t) over time from n=0 to n=max exceeds anywhere along the time line a predetermined threshold value, i.e., if the peak of the sensitivity has exceeded a certain threshold or a certain slope. If not, then the program will flow from the decision block 1526 along a “N” path to a function block 1528 to indicate a discard operation, wherein the input is determined not to affect the output. If the sensitivity, i.e., the change of the output compared to that input, exceeds the threshold at any point along the time line thereof, this is indicated as an input that has an effect on the output, i.e., the output is sensitive to that input. The program will then flow along the “Y” path to a function block 1530 to select that input as a sensitive input. The program then flows to an END block 1532 for that input xₘ(t). Thereafter, each other input is selected, i.e., the value of “m” is incremented.

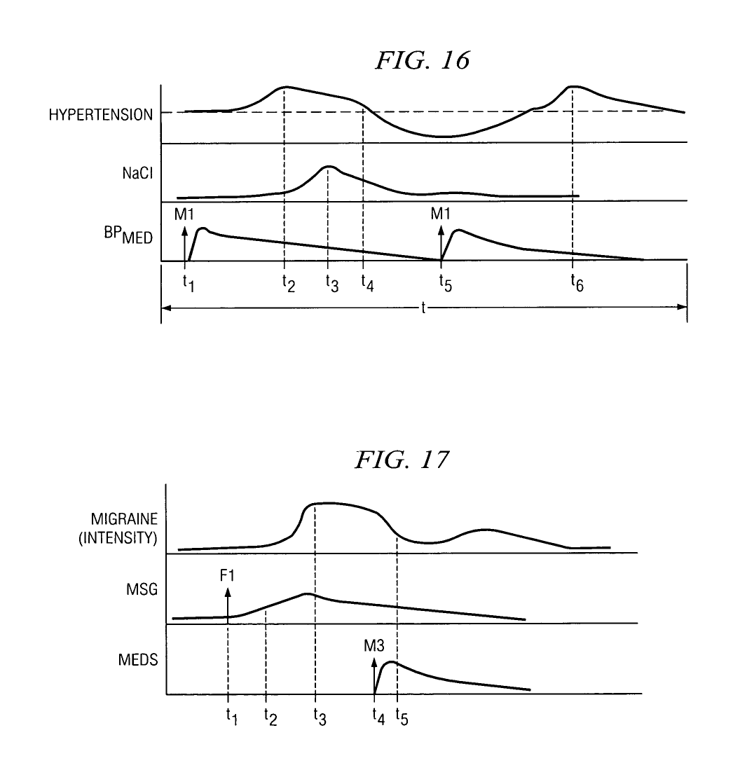

Referring now to FIGS. 16 and 17, there are illustrated plots for two results of the sensitivity analysis. The plot of FIG. 16 is associated with hypertension. This is a time series plot that shows hypertension initially unaffected by anything, i.e., the dotted line. A particular blood pressure medicine is taken which causes a positive result, i.e., hypertension is sensitive to the intake of a medicine, M₁, at a time t₁. However, it is at a time t₂ that the actual sensitivity, i.e., the beneficial effect, is noted. However, even with the blood pressure medicine, which is a time release medicine, there is shown an initial benefit at a peak at time t₂ which decreases thereafter. However, at a time t₃, the blood serum level of a sodium chloride intake peaks. This results in a notable decrease at a later time, t₄, in the beneficial aspect of the drug M₁ to hypertension, i.e., the slope of the change is noticeably changed which will then go down to a value opposite therefrom, this being due to the fact that the medicine is wearing off. At a time t₅, M₁ is again ingested and results in a peak sensitivity in hypertension at time t₆. Therefore, the physician when reviewing this information can determine if the individual is sensitive to sodium chloride and if the blood pressure medication is working as intended. The sensitivity analysis determines that both that particular medication and the sodium chloride caused the blood pressure to vary to a noticeable extent above a predetermined threshold and, as such, determined that these two inputs were of particular interest.

With reference now to FIG. 17, there is illustrated an example of a migraine headache. The actual data for the model that was input thereto is compared to the output and a sensitivity associated therewith determined. Initially, there will be no migraine headache and, as such, the sensitivity of the intensity will be minimal to all other inputs. However, at a time t₁, a large intake of MSG occurs as an intake of a food product F1. It is determined that the MSG in this food causes the largest effect in the migraine headache. At a time t₃, the sensitivity of the migraine headache to the blood serum level shows a strong relationship to the peak in the MSG level. It can be seen that, as the MSG level decreases, the intensity may not increase. At a time t₄, a medication is taken, such as aspirin or some type of analgesic. The blood serum level of the medication will increase relatively quickly, as this is the desired way that this medicine should act. This causes a decrease in the sensitivity of MSG to the intensity of a migraine, as one would expect. However, as the medication wears off, the sensitivity of the migraine headache intensity will increase, this indicated at a time t₅.

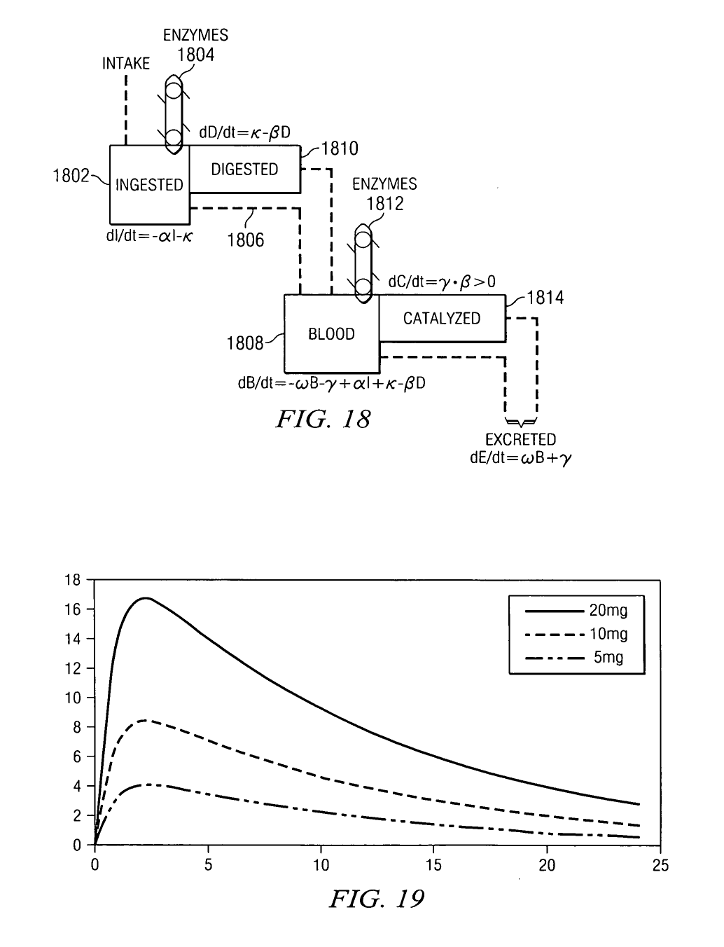

Referring now to FIG. 18, there is illustrated a block diagram of one of the first principles models 804, this being a universal model. This model can be utilized for such things as fats, drugs, carbohydrates, etc. This model need only be parameterized and is based on an algorithm that receives as input the intake of a particular substance and then determines at a block 1802 how that product is digested. The block 1802 calculates this as a function of the ingested amount of the product, as a function of time, the absorption rate and the digestion rate. A path 1806 indicates the amount of product that is passed to the blood, as indicated by a block 1808. This indicates the blood amount of the product due to ingestion. Further, some of this product will be digested, as indicated by block 1810. A certain amount of this product will also be introduced into the blood due to the digestion process. Various enzymes also are provided as inputs, as indicated by input 1804. These enzymes will affect the way a particular product, medicine, etc., is digested or handled by the stomach. In the blood, enzymes are also important, as indicated by an input 1812. This model determines how much of the product is excreted directly from the blood and how much is catalyzed, as indicated by block 1814, which also determines a certain amount that will be excreted. Overall, this model of FIG. 18 will provide, once properly parameterized, the ability to generate a time series of data points indicating how a particular product is metabolized by the physiological system.

The relevant internal variables for the modal of FIG. 18 are:
Ingested amount=I
Blood amount=B

The relevant parameters for the model are:
Digestion rate=κ
Absorption rates=α,β
Conversion rate=γ
Excretion rate=ω

The model equations are then:
dI/dt=−αI−κ
dB/dt−−ωB−γ+αl+κ−βD
dD/dt=κ−βD
In most cases, these parameters are not available directly, but most infer them from values such as the excretion half-life T_{1/2} and the time of maximum blood levels, Tₘₐₓ. For most medications, the digestion and conversion rates are small or zero, and, as such, it is only necessary to estimate the absorption and excretion rates α and ω. This is equivalent to the physical model of two leaky cylindrical containers, one leaking into the other which again leaks out. The system of equations is then given by:
dI/dt=αl
dB/dt=−ωB+αl
which can be solved exactly for the case of a single ingested amount I₀ by converting to matrix form:
dV/dt=MV
where V the column vector [I,B] and M is the coefficient matrix [−α,0][α,−ω]. This matrix equation has the solution:
V=exp(Mt)V₀
Where exp(Mt) is the exponentiation of M as a matrix taylor series, and V₀ is the initial vector. Inserting M=PDP⁻¹ where D is a diagonal matrix in the taylor series gives:
exp(Mt)=Pexp(Dt)P⁻¹
The eigenvalues are easily given by setting det(D−λI)=0 giving (−α−λ)(−ω−λ)=0, and so
λ=−α,−ω
D=[−α,0][0,−ω]
Solving for the eigenvectors of comprising P gives the following relationship:
P=[ω−α)/α,0][1,1]
P⁻¹=[α/(ω−α),0][−α/(ω−α),1]
exp(Dt)=[exp(−αt),0][0,exp(−ωt)], and so multiplying out V=Pexp(Dt)P
31 1V₀ with initial condition V₀=[I₀,0] gives:

[symbol]

Solutions are then:
I=I₀exp(−α(t−t₀))
B=I₀α/(ω−α)(exp(−α(t−t₀))−exp(−ω(t−t₀)))
When t=t₀ we see that B=0 as expected. Furthermore, computing dB/dt=0 to find Cₘₐₓ and Tₘₐₓ gives:
Tₘₐₓ=1n(ω/α)/(ω−α)
Cₘₐₓ=I₀α/(ω−α)((ω/α)\hat{ }(α/(α−ω))−α/ω\hat{ }(ω/ω−α)))
It is noted that Tₘₐₓ is symmetric in ω and α; i.e. swapping the values of ω and α produces the same result. In addition, swapping the values of ω and α produces a curve for B which has the same shape, scaled by a factor of ω/α. In the special case where ω=α, the following is provided:
Tₘₐₓ₌1/α=1/α
Cₘₐₓ=I₀exp(−1)
The excretion coefficient ω is easily computed from the half-life as:
ω=1n(2)/T_{1/2}
From this, the absorption coefficient α can be computed from Tₘₐₓ by the following interactive formula (which converges to the correct value as K→∞)
αₖ₊₁=ω+(1n(αₖ)−1n(ω))/Tₘₐₓ

### EXAMPLE

For the COX-2 inhibitor arthritis drug BEXTRA (generic name Valdecoxib), the given physiological parameters are:
Area_Under_Curve(24 hr)(hr*ng/mL)=1479.0
Cₘₐₓ=161.1 ng/mL
Cₘₐₓ/AUC=161.1/1479.0=0.108925
Tₘₐₓ=2.25 hr
Cₘᵢₙ=21.9 ng/mL at 14 day equilibrium

Elimination Half-Life=8.11 hr

Therefore,
ω=In(2)/8.11=0.085468/hr
α=1.292751/hr
C_{max(calc)}=8.24819 mg after 2.25 hr
AUC_{(calc) 24} hr)=100.8914 hr*mg

This will allow an estimate of:
AUC hr*ng/mL=Cₘₐₓ ng/mL*AUC_{calc} mg*hr/C_{max(calc)} mg=1970 hr*ng/mL˜1479 (the given value).

The calculated value is within ±25% of the experimental value.

Referring now to FIG. 19, there is illustrated an output of the model of FIG. 18 for the example for the Bextra drug. This shows three waveforms, one for a 5 mg. dose, one for a 10 mg. dose and one for a 20 mg. dose. The x-axis is set forth in increments of fifteen minutes of time. Therefore, the term “5” provides for one hour and fifteen minutes of time.

Although the preferred embodiment has been described in detail, it should be understood that various changes, substitutions and alterations can be made therein without departing from the spirit and scope of the invention as defined by the appended claims.

1. A method for monitoring the wellness state of a given human body of a person, comprising the steps of:
sensing measurable physiologic parameters of the physiologic metabolism of the given human body;
determining perceived physiologic parameters of the physiologic metabolism of the given human body through interface with the human brain associated with the given human body, which perceived physiologic parameters are parameters relating to the physiologic metabolism of the given human body that can only be determined by interface of the human brain with the physiologic metabolism of the associated given human body;
wherein the sensed measured physiologic parameters and the determined perceived physiologic parameters comprise an input vector; and
processing the input vector through a model of the given human body that is trained on a training data set comprised of historical measured physiologic parameters of the physiologic metabolism of the given human body that are sensed over time in conjunction with historical perceived physiologic parameters of the physiologic metabolism of the given human body, wherein the input vector comprises less than the set of historical measured physiologic parameters and the set of historical perceived physiologic parameters, the output of the model providing a prediction of wellness of the given human body.

2. The method of claim 1, wherein the ratio of measured physiologic parameters in the input vector to the historical measured physiologic parameters is substantially greater than the ratio of the perceived physiologic parameters in the input vector to the historical perceived physiologic parameters.

3. The method of claim 1, wherein the interface to the human brain comprises an audible interface.

4. The method of claim 1, wherein the interface to the human brain comprises a tactile interface.

5. The method of claim 4, wherein the tactile interface comprises a written interface.

6. The method of claim 1, and further comprising the step of measuring external parameters that affect the physiologic metabolism of the given human body and the input vector includes the measured external parameters and the training data set includes historical external parameters.

7. The method of claim 6, wherein the external parameters include environmental parameters.

8. The method of claim 6, wherein the environmental parameters include environmental parameters from the group of relative humidity, pollen count, mold count, ambient temperature, air quality and barometric pressure.

9. The method of claim 1, wherein the model is a linear model.

10. The method of claim 1, wherein the model is a non-linear model.

11. The method of claim 10, wherein the non-linear model comprises a neural network.

12. The method of claim 1, wherein the measured physiologic parameters are selected from the group of blood pressure, body temperature, pulse, blood chemistry, pedometer count, and urine chemistry.

13. The method of claim 1, wherein the historical perceived physiologic parameters are collected by the steps of recording perceived parameters of the wellness of the given human body by the associated brain and recording such perceptions.

14. The method of claim 13, wherein the step of recording comprises responding to predetermined queries at predetermined times over a set time span.

15. The method of claim 1, wherein the model comprises a representation of the physiological metabolism of the given human body combined with the inherent learned behavior of the associated brain when making perceptions of the physiological metabolism of the given human body.

16. A method for determining sensitivities of the metabolism of the human body for an individual to their surrounding, comprising the steps of:
collecting metabolic data that is measurable of the state of the individual's metabolism over a a determinable time period, which collected metabolic data comprises measurable variables of the metabolism associated with the human body of the individual;
collecting perceptions from the individual over the determinable time period about their perceived state of wellness, which collected perceptions comprise perceived variables;
the collected metabolic data and perceptions comprising historical data associated with that individual;
training a model on the historical data to model one or more parameters relating to the metabolism of the individual with select ones of the measured and perceived variables comprising inputs to the model and others thereof comprising outputs to the model; and
determining the sensitivity of the one or more parameters on which the trained model was trained on one or more of the perceived and measured variables that comprised inputs to the model over time.

17. The method of claim 16, wherein at least one of the measured variables comprises products ingested by the individual during the determinable time period.

18. The method of claim 18, wherein the products ingested are metabolized by the human body of the individual over the determinable time period in a known manner and the model is trained with the known manner that the ingested product is metabolized over the determinable time period as one of the inputs to the model, and wherein the sensitivity of one of the outputs of the model can be determined on the amount of the ingested product at the time of ingestion relative to the determinable period of time.

19. The method of claim 18, wherein the known manner can be determined for a generalized human body that is modeled on observations and measurements taken over a cross section of human bodies.

20. The method of claim 19, wherein the ingested product is modeled with a first principles model that models metabolism of the ingested product as a function of time and the amount of the ingested product.

21. The method of claim 18, wherein the known manner that the ingested product is metabolized is specific to the individual.

22. The method of claim 16, wherein the measurable variables include external parameters that affect the physiologic metabolism of the human body of the individual over the determinable time period.

23. The method of claim 22, wherein the external parameters include environmental parameters.

24. The method of claim 22, wherein the environmental parameters include environmental parameters from the group of relative humidity, pollen count, mold count, ambient temperature, air quality and barometric pressure.

25. The method of claim 16, wherein the measured variables are selected from the group of blood pressure, body temperature, pulse, blood chemistry, pedometer count, and urine chemistry.

26. The method of claim 16, wherein the perception by the individual are collected by the steps of the individual recording perceived parameters as they personally perceive them of the wellness of their human body by the associated brain and recording such perceptions.

27. The method of claim 26, wherein the step of recording comprises responding to predetermined queries at predetermined times over the predetermined time period.

28. The method of claim 16, wherein the model comprises a representation of the physiological metabolism of the individual's human body combined with the inherent learned behavior of the associated brain when making perceptions of the physiological metabolism of the individual's human body.
